(19) United States
(12) Patent Application Publication
(10) Pub. No.: US 2026/0127689 A1
(43) Pub. Date: May 7, 2026

(54) SYSTEM AND METHOD FOR REAL-TIME RETRIEVAL OF REAL ESTATE LISTING DATA

(71) Applicant: Rory James Higgins, Houston, TX (US)

(72) Inventor: Rory James Higgins, Houston, TX (US)

(21) Appl. No.: 19/369,685

(22) Filed: Oct. 27, 2025

Related U.S. Application Data
(60) Provisional application No. 63/712,466, filed on Oct. 27, 2024.

(51) Int. Cl. G06Q 50/163; G06Q 30/0201

(52) U.S. Cl. CPC G06Q 50/163; G06Q 30/020121

(57) ABSTRACT

A system and method provide real-time lead identification and lifecycle monitoring for real estate listing opportunities earlier than conventional batch-processing platforms. The system incorporates a Predictive Expiration Monitoring (PEM) engine module to analyze active listing records and schedule delivery of lead notifications to subscribing professionals prior to a contractual expiration event. Concurrently, a Reactive Delisting Detection (RDD) engine module continuously monitors MLS data in real-time to detect and immediately deliver leads corresponding to status changes such as Cancelled, Terminated, or Withdrawn. All delivered leads are enrolled in a continuous monitoring service that tracks the property for subsequent reactivation or relisting in a non-expired status. Upon detecting such an event, the system automatically generates a compliance notification, instructing the subscriber to cease further outreach. This integrated system significantly improves conversion rates and reduces competition by providing actionable, timely data, optionally enhanced by machine-learning ranking and filtering criteria.

### CROSS-REFERENCE TO RELATED APPLICATION

This application claims priority to U.S. Provisional Patent Application No. 63/712,466, filed Oct. 27, 2024, titled “System and Method for Real-Time Retrieval of Real Estate Listing Data,” the entirety of which is incorporated herein by reference.

### FIELD OF INVENTION

The present invention relates to systems and methods for providing real-time data on real estate listings that have been cancelled, expired, terminated, or withdrawn from a multiple listing service (MLS).

### BACKGROUND OF THE INVENTION

In the real estate industry, accessing timely and accurate data on property listings is critical for real estate professionals, particularly when a listing's status changes to cancelled, expired, terminated, or withdrawn from the Multiple Listing Service (MLS). When a listing is removed from the market without selling, real estate agents or investors often attempt to contact the homeowner in hopes of securing the property for re-listing.

However, current systems that provide this data suffer from several critical deficiencies. First, existing services that offer expired, cancelled, withdrawn, or terminated listing data rely on batch processing methods that deliver the data in bulk at a fixed time each day, usually the morning after the listing status changes. This delay results in intense competition, as numerous agents or investors simultaneously contact the same homeowners, leading to frustration for homeowners and a low success rate for agents or investors. These services do not offer the real-time data access required to gain a competitive advantage.

Second, these conventional providers are purely reactive. They generally wait for an explicit status change to occur—such as a listing transitioning to “Expired”—before distributing the lead. They lack any mechanism to predict an upcoming expiration based on MLS metadata before the expiration event occurs, failing to provide agents with the earliest possible opportunity to make contact.

Third, existing systems that deliver these leads often fail to provide effective or timely subsequent lifecycle monitoring. Any monitoring provided typically suffers from the same delays as their initial lead delivery, such as relying on batch processing, rather than continuous, real-time tracking. This creates a new problem where an agent may continue to expend effort, or risk compliance violations, by contacting a homeowner who has already relisted the property with a new professional. These systems lack an integrated and continuous lifecycle monitoring or compliance notification mechanism to immediately inform the agent when outreach should cease

Therefore, there is a clear and unmet need for a comprehensive, integrated system that overcomes all of these deficiencies. A need exists for a system that not only (1) provides real-time access to cancelled, withdrawn, or terminated listing data, but also (2) predictively identifies leads before they expire, and (3) provides continuous lifecycle monitoring to issue compliance notifications when a lead is relisted. The present invention addresses these needs by offering a solution that delivers predictive, real-time, and continuously monitored property status updates.

### SUMMARY OF THE INVENTION

In light of the disadvantages mentioned in the previous section, the following summary is provided to facilitate an understanding of some of the innovative features unique to the present invention and is not intended to be a full description. A full appreciation of the various aspects of the invention can be gained by taking the entire specification and drawings as a whole.

The present invention is a system and corresponding method for the real-time retrieval of real estate listing data. The system significantly improves upon conventional data processing methods by combining two distinct detection mechanisms to provide real estate professionals with timely, actionable leads.

The system comprises a data ingestion interface module configured to receive and normalize real estate listing records from one or more Multiple Listing Service (MLS) databases. This normalized data is processed by two primary engine modules.

First, the predictive expiration monitoring (PEM) engine module is configured to analyze active listing records having an Expiration Date metadata field and to schedule delivery of a lead notification to a subscribing real estate professional prior to a listing expiration event while the listing remains in an active status. In some embodiments, this delivery is scheduled for a predetermined time on the Expiration Date.

Second, the reactive delisting detection (RDD) engine module is configured to continuously monitor the MLS records for status changes in real-time. This module detects a status change of a listing to a delisted status, including Cancelled, Terminated, or Withdrawn, and delivers a corresponding lead notification substantially immediately upon detection of the status change, potentially within a configurable time period of less than one hour.

The system further includes a monitoring service module which enrolls all delivered lead notifications from both the PEM engine module and the RDD engine module into a continuous monitoring queue. This service is critical for compliance, as it generates a compliance notification to the subscribing real estate professional when a listing previously delivered as a lead is subsequently detected as being relisted or reactivated in a non-expired status. The monitoring service module cross-references a Storage Module containing historical delivery records to ensure targeted delivery of the compliance notification.

To enhance lead quality, the system may utilize a Data Processing Module configured to filter listing records to ensure the property has not been re-entered into the MLS as a new active listing. Furthermore, a classification module can rank or filter the delivered leads using a machine-learning algorithm trained on historical conversion outcomes. A User Interface Module is provided to allow the professional to set and apply filtering options based on criteria such as geographic location, property type, and price range. The system may also include an Alert Communication Module configured to integrate the lead notification directly with an external Customer Relationship Management (CRM) system.

This summary is provided merely for the purpose of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

The above-mentioned embodiments and further variations of the proposed invention are discussed further in the detailed description.

### BRIEF DESCRIPTION OF THE DRAWINGS

FIG. 1 illustrates a system for real-time retrieval of real estate listing data according to the embodiments of the present disclosure; and

FIG. 2 illustrates a method for real-time retrieval of real estate listing data according to the embodiments of the present disclosure.

FIG. 3 is a flowchart illustrating an example workflow for the Reactive Delisting Detection (RDD) engine, showing the live monitoring of a status stream, detection of Cancelled/Terminated/Withdrawn, immediate delivery, and monitoring.

FIG. 4 is a diagram illustrating the Predictive-to-Reactive integration, showing PEM output entering the monitoring queue and the continuation of monitoring by the RDD engine.

FIG. 5 is a block diagram illustrating the flow of the notification subsystem, including multi-channel delivery and timestamp logging.

FIG. 6 is a block diagram of an optional AI-based prioritization subsystem for ranking or filtering leads.

FIG. 7 illustrates an example user interface displaying delivered leads and corresponding compliance status indicators.

### DETAILED DESCRIPTION OF THE DRAWINGS

In the following description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention.

The specification may refer to “an”, “one” or “some” embodiment(s) in several locations. This does not necessarily imply that each such reference is to the same embodiment(s), or that the feature only applies to a single embodiment. Single feature of different embodiments may also be combined to provide other embodiments.

As used herein, the singular forms “a”, “an” and “the” are intended to include the plural forms as well unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries should be interpreted as having a meaning that is consistent with their meaning in the context of the relevant art and will not be interpreted in an idealized or overly formal sense unless expressly so defined herein.

The utility of the devices described herein will be explained further in detail in the following sections of this document referring to the figures. Specific terms used herein do not restrict the scope of the present disclosure.

According to the embodiments of the present disclosure, a system and method for real-time retrieval of real estate listing data is disclosed.

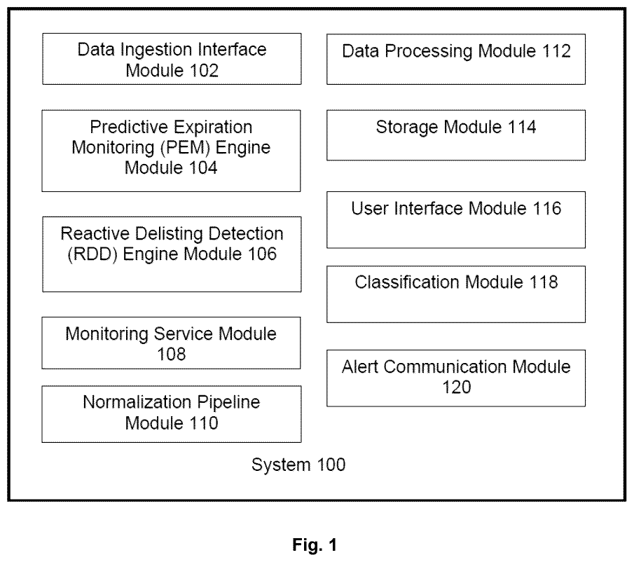

FIG. 1 illustrates a system 100 for real-time retrieval of real estate listing data according to the embodiments of the present disclosure. The system 100 is a computer-implemented system for the early identification and complete lifecycle monitoring of real estate listing opportunities. The system 100 comprises a data ingestion interface module 102 configured to receive and normalize real estate listing records from one or more Multiple Listing Service (MLS) databases. The system 100 further includes two primary analysis engines. A predictive expiration monitoring (PEM) engine module 104 is configured to analyze active listing records having an Expiration Date metadata field and to schedule the delivery of a lead notification to a subscribing real estate professional prior to the listing expiration event, while the listing remains in an active status. Concurrently, a reactive delisting detection (RDD) engine module 106 is configured to continuously monitor the MLS records for status changes in real-time. This RDD engine module 106 detects a status change of a listing to a delisted status, such as Cancelled, Terminated, or Withdrawn, and delivers a corresponding lead notification substantially immediately upon detection of that status change. The system 100 also includes a monitoring service module 108 configured to enroll all delivered lead notifications from both the PEM engine module 104 and the RDD engine module 106 into a continuous monitoring queue. The monitoring service module 108 is further configured to generate a compliance notification to the subscribing real estate professional when a listing previously delivered as a lead is subsequently detected as being relisted or reactivated in a non-expired status.

As shown in FIG. 1, the system 100 may further comprise a normalization pipeline module 110. This module 110 is configured to map disparate MLS record fields, which may vary significantly between different MLS databases, into a canonical data schema. This normalization process ensures that data is in a consistent and predictable format prior to being processed by the PEM engine module 104 and the RDD engine module 106.

In an embodiment, the PEM engine module 104 is configured to schedule the delivery of its lead notification at a predetermined time on the Expiration Date. For example, the system 100 may be configured to send the notification at 6:00 a.m. on the day of expiration, providing the subscribing real estate professional with the actionable lead data hours before the listing's status officially changes.

To maximize the competitive advantage of the reactive detection, the RDD engine module 106 is configured to deliver its corresponding lead notification substantially immediately. In one embodiment, this is achieved by transmitting the notification, via the Alert Communication Module 120, within a configurable time period of less than one hour after the RDD engine module 106 first detects the status change.

The system 100 may further comprise a Data Processing Module 112 configured to perform an additional filtering step to improve lead quality. This module 112 filters the listing records based on a determination that the property associated with the delisted status has not already been re-entered into the MLS as a new active listing, thereby preventing the system from sending a notification for a property that is already under contract with a new agent.

The monitoring service module 108 provides continuous oversight of a lead after it has been delivered. In one configuration, the monitoring service module 108 is configured to actively track the status of the listing for at least 30 days after the listing is first delivered as a lead notification to the subscribing real estate professional, ensuring any immediate relisting is captured.

To properly manage and direct the compliance notifications, the monitoring service module 108 is configured to cross-reference a Storage Module 114. This Storage Module 114 contains historical delivery records, including which subscriber received which lead and when. This allows the system to determine the specific subset of subscribing real estate professionals who previously received the lead notification, ensuring that the compliance notification is only sent to those targeted recipients.

The system 100 further comprises a User Interface Module 116. This module 116 provides a front-end, which may be a web application or mobile application, allowing the subscribing real estate professional to interact with the system. The User Interface Module 116 is configured to allow the subscriber to set and apply filtering options, such as criteria selected from geographic location, property type, and price range, so they only receive leads that are relevant to their business.

In an advanced embodiment, the system 100 may include a classification module 118. This module 118 is configured to rank or filter the delivered leads using a machine-learning algorithm. This algorithm may be trained on historical conversion outcomes or anomaly detection to score the quality of a lead, allowing the subscriber to prioritize their outreach efforts on leads that are most likely to convert.

Finally, the system 100 includes an Alert Communication Module 120 to manage the delivery of all notifications. This module 120 is configured to not only transmit alerts via various channels, such as email, SMS, or push notifications, but also to integrate the lead notification directly with an external Customer Relationship Management (CRM) system used by the subscribing real estate professional, thereby automating their client intake and workflow.

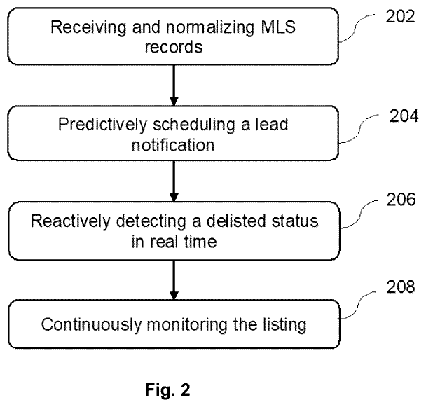

FIG. 2 illustrates a method for real-time retrieval real estate listing data according to the embodiments of the present disclosure. The method comprises at step 202, receiving and normalizing MLS records from a data ingestion interface module (102).

At step 204, the method comprises predictively scheduling a lead notification via a PEM engine module (104). This predictive scheduling step is performed by analyzing an Expiration Date field of an active listing record and scheduling delivery of the lead notification to a subscribing real estate professional prior to a listing expiration event.

At step 206, the method comprises reactively detecting a delisted status in real time via an RDD engine module (106). This reactive detection step is performed by continuously monitoring the MLS records for status changes, detecting a transition of a listing to a delisted status, including Cancelled, Terminated, or Withdrawn, and delivering a corresponding lead notification substantially immediately upon detection.

Finally, at step 208, the method comprises continuously monitoring the listing via a monitoring service module (108). This continuous monitoring step is performed by maintaining a status lineage record of the listing following delivery of the lead notification and automatically generating a compliance notification to the subscribing real estate professional upon detecting a subsequent relisting or reactivation of the property to a non-expired status.

In one embodiment of the method, the step of predictively scheduling delivery comprises selecting a delivery time on the Expiration Date for the active listing that is prior to the listing's actual expiration time. This provides a significant advantage by allowing the subscribing real estate professional to receive the lead notification, for example, at the beginning of the business day on which the listing is set to expire, rather than waiting for the expiration event to occur.

The method may further comprise, prior to delivering the corresponding lead notification from the reactive detection step, the additional step of filtering the listing using a Data Processing Module (112). This filtering is performed to confirm the listing has not been relisted with a different MLS number, which prevents the system from sending alerts for properties that have already been secured by another agent and are not truly available.

In some embodiments, the method further comprises aggregating data from multiple real estate markets across different geographical regions. This aggregation step occurs prior to the predictive scheduling and reactive detection steps, allowing the system to provide a comprehensive service across various MLS domains.

The step of delivering the lead notification and the compliance notification includes transmitting the notification via one or more communication channels managed by the Alert Communication Module (120). These channels are selected from, but not limited to: email, SMS, and mobile application push notification, ensuring the subscribing real estate professional receives the time-sensitive data through their preferred medium.

The method may further comprise the step of ranking or filtering the delivered leads using a classification module (118). This module utilizes a machine-learning model trained on historical conversion outcomes or anomaly detection to prioritize delivery, allowing the subscribing real estate professional to focus on leads with the highest likelihood of success.

To enable the generation of compliance notifications, the step of continuously monitoring the listing via the monitoring service module (108) comprises cross-referencing a Storage Module (114) containing historical data. This cross-referencing is performed to associate the relisted property with the previous lead notification record, thereby identifying the specific subscribers who originally received the lead and must be alerted to the change in status.

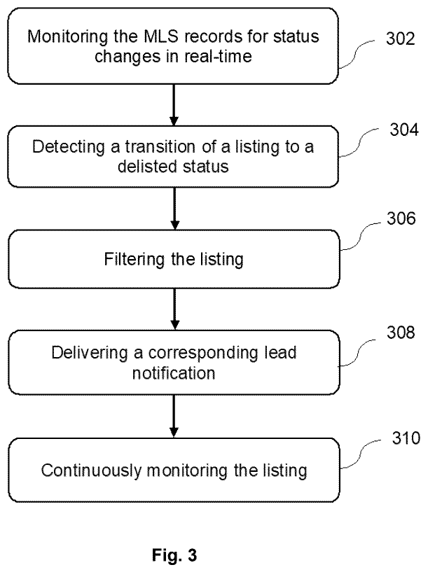

FIG. 3 illustrates a method 300 for the reactive delisting detection and lifecycle management of real estate listing opportunities, according to the embodiments of the present disclosure. This method 300 corresponds to the workflow of the reactive delisting detection (RDD) engine module (106).

The method 300 begins at step 302, which comprises continuously monitoring the MLS records for status changes in real-time. This step is performed by the RDD engine module 106, which ingests a live data stream from the data ingestion interface module 102.

At step 304, the method 300 comprises detecting a transition of a listing to a delisted status. This detection is triggered when the RDD engine module 106 identifies a status change to one of the predefined delisted statuses, which include Cancelled, Terminated, or Withdrawn.

Following detection, the method 300 may optionally proceed to step 306, which comprises filtering the listing using a Data Processing Module (112). This step is performed to confirm it has not been relisted with a different MLS number. This ensures that the lead is valid and has not been immediately re-entered into the MLS, which would make it an invalid lead.

At step 308, the method 300 comprises delivering a corresponding lead notification substantially immediately upon detection (and successful filtering). This delivery step includes transmitting the notification via one or more communication channels managed by an Alert Communication Module (120), such as email, SMS, and mobile application push notification. In some embodiments, the method may also comprise ranking or filtering the delivered leads using a classification module (118) at this stage.

Finally, at step 310, the method 300 comprises continuously monitoring the listing by enrolling it in the workflow of the monitoring service module (108). This is a critical handoff from the RDD engine 106 to the monitoring service 108. This monitoring step comprises maintaining a status lineage record of the listing and cross-referencing a Storage Module (114) containing historical data. This allows the system to automatically generate a compliance notification if the property is subsequently relisted or reactivated.

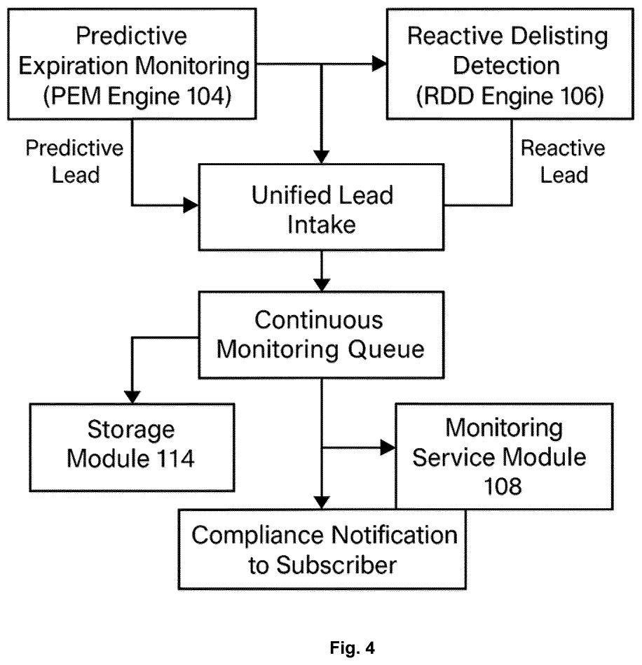

FIG. 4 illustrates a diagram of the Predictive-to-Reactive Integration and the continuous lifecycle monitoring workflow. This figure illustrates how leads generated by both the predictive expiration monitoring (PEM) engine module 104 (detailed in FIG. 2) and the reactive delisting detection (RDD) engine module 106 (detailed in FIG. 3) are handled by a single, unified monitoring process.

As described, the monitoring service module 108 is configured to enroll all delivered lead notifications—regardless of their origin from either the PEM engine or the RDD engine—into a continuous monitoring queue. This enrollment represents a critical “handoff” from the initial detection phase (predictive or reactive) to the continuous lifecycle monitoring phase.

The method of this monitoring phase comprises maintaining a status lineage record of the listing following the delivery of the initial lead notification. To achieve this, the monitoring service module 108 is configured to cross-reference a Storage Module (114) containing historical data. This cross-referencing allows the system to associate the relisted property with the previous lead notification record and definitively identify the original subscriber(s) who received that lead.

The primary function of this continuous monitoring is to automatically generate a compliance notification to the subscribing real estate professional. This notification is generated upon the system detecting a subsequent relisting or reactivation of the property to a non-expired status, thereby informing the subscriber that they should cease outreach efforts.

In one embodiment, the monitoring service module 108 is configured to track the status of the listing for at least 30 days after the listing is delivered as a lead, though in other embodiments, this monitoring may continue indefinitely to ensure subscriber compliance.

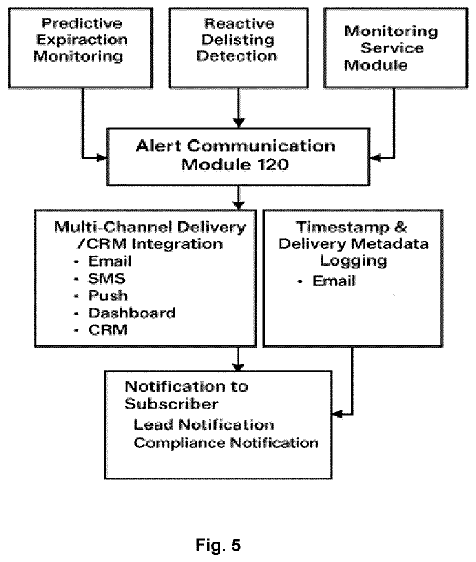

FIG. 5 illustrates a block diagram of the Notification Subsystem, which is managed by the Alert Communication Module (120). This subsystem is responsible for handling the generation and transmission of all alerts to the subscribing real estate professional.

The subsystem is shown receiving inputs, which are notification triggers generated by the monitoring service module (108). These triggers may correspond to an initial lead notification (from either the PEM engine 104 or the RDD engine 106) or to a compliance notification.

Upon receiving a trigger, the Alert Communication Module (120) executes a “Generate and Send Notification” process. This method of delivery comprises transmitting the notification via one or more communication channels. As shown in the diagram, these channels include a primary channel, such as an Email Server, and may also include optional secondary channels selected from: SMS (text message), Push notifications to a mobile application, and alerts delivered to a Web Dashboard, which may be a component of the User Interface Module (116).

The diagram also depicts a Timestamp Logger associated with the outputs. This function corresponds to the system's interaction with the Storage Module (114). When a notification is successfully delivered, a historical delivery record is logged. This log, which forms part of the status lineage record, is critical for the monitoring service module's (108) ability to cross-reference historical data and determine which subscribers must receive a future compliance notification.

Furthermore, the Alert Communication Module (120) is also configured to perform an additional function beyond simple alerts. It is configured to integrate the lead notification with an external Customer Relationship Management (CRM) system used by the subscribing real estate professional, thereby automatically populating the lead data into their existing workflow.

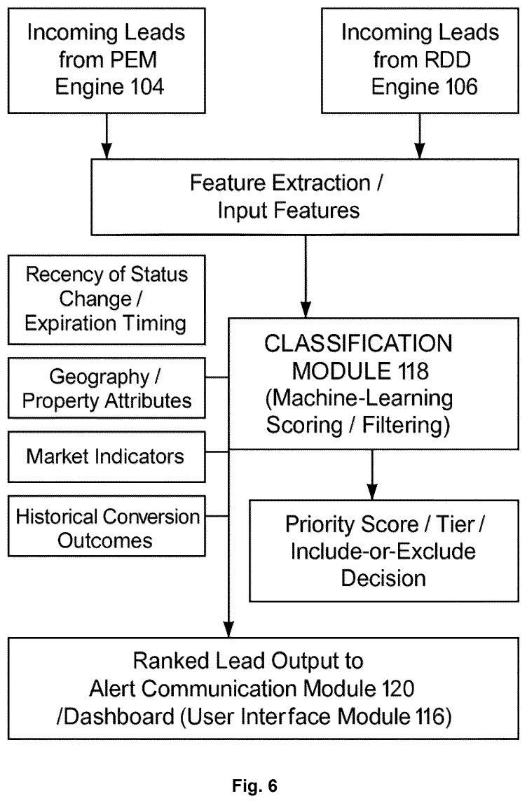

FIG. 6 illustrates a block diagram of an optional AI Prioritization Subsystem, which corresponds to the classification module (118). This module 118 functions as an advanced filter or scoring engine to enhance the quality of leads delivered to the subscribing real estate professional.

As detailed, the classification module (118) is configured to rank or filter the delivered leads. This is accomplished by employing a machine-learning algorithm, depicted as the “Classifier Block” or “Machine-Learning Model” in the figure.

As shown in the diagram, this module 118 is configured to accept various data features as inputs. These features may include, but are not limited to, the lead's Recency, its Geography (such as ZIP code or county), property characteristics, and other data points.

The machine-learning algorithm is trained on historical conversion outcomes and/or anomaly detection. By analyzing these features against past performance, the module 118 generates a score or a binary pass/fail classification for the lead. The output of this module 118 is then used to prioritize delivery or filter the leads that are ultimately sent to the subscriber via the Notification Subsystem (FIG. 5), thereby allowing the subscribing real estate professional to focus their efforts on opportunities with the highest likelihood of conversion.

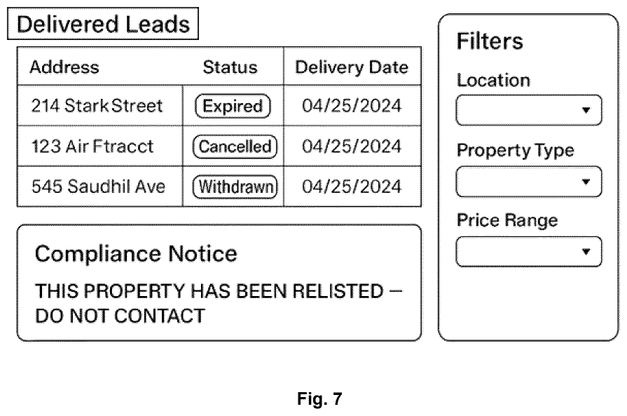

FIG. 7 illustrates an example of an Agent User Interface, which is a component of the User Interface Module (116). This module 116 provides the front-end dashboard that allows the subscribing real estate professional to receive and manage leads.

As shown in the figure, the User Interface Module (116) is configured to display a list of delivered leads, for example, in a table format showing the property address and its current status. These statuses, shown as “status badges,” correspond to the detection event that generated the lead. For example, the interface displays leads identified by the PEM engine module (104) (e.g., “Expired”) as well as leads identified by the RDD engine module (106) (e.g., “Cancelled,” “Terminated,” “Withdrawn”).

A primary feature of the User Interface Module (116), illustrated by the highlighted banner, is its ability to display the compliance notification generated by the monitoring service module (108). As described, when a previously delivered lead is subsequently detected as being relisted or reactivated, the interface is updated to display this status (e.g., “Reactivated”) and presents a clear warning, such as the “Compliance Notice: This Property Has Been Relisted—Do Not Contact.”

In addition to displaying leads and compliance notices, the User Interface Module (116) is further configured, to allow the subscribing real estate professional to set and apply filtering options. These filtering options, which are then used by the system to determine which leads to deliver, are based on at least one criteria selected from: geographic location, property type, and price range.

Overall, the present invention achieves a significant technical advancement over conventional batch-processing systems by providing a fully integrated, multi-stage platform for lead identification and lifecycle management. It uniquely combines a predictive expiration monitoring (PEM) engine module, which analyzes active listing metadata to deliver leads before an expiration event occurs, with a reactive delisting detection (RDD) engine module that captures delisted statuses like ‘Cancelled’ or ‘Terminated’ in real-time, thereby eliminating the data lag inherent in prior art. Furthermore, the invention introduces a novel monitoring service module that tracks the lead's status after delivery, solving the unaddressed problem of post-delivery relisting by automatically generating a compliance notification to the subscriber, which prevents wasted effort and reduces compliance risk. This combination of predictive scheduling, real-time reactive detection, and continuous lifecycle monitoring provides a comprehensive technical solution that is demonstrably superior to existing systems.

The present description has been shown and described with reference to the foregoing embodiments. It is understood, however, that other forms, details, and examples can be made without departing from the spirit and scope of the present subject matter.

I claim:

1. A system for real-time retrieval of real estate listing data, the system comprising:
a data ingestion interface module configured to receive and normalize real estate listing records from one or more Multiple Listing Service (MLS) databases;
a predictive expiration monitoring (PEM) engine module configured to:
analyze active listing records having an Expiration Date metadata field; and
schedule delivery of a lead notification to a subscribing real estate professional prior to a listing expiration event while the listing remains in an active status;
a reactive delisting detection (RDD) engine module configured to:
continuously monitor the MLS records for status changes in real-time;
detect a status change of a listing to a delisted status, wherein the delisted status includes Cancelled, Terminated, or Withdrawn; and
deliver a corresponding lead notification substantially immediately upon detection of the status change; and
a monitoring service module configured to:
enroll all delivered lead notifications from the PEM engine and the RDD engine into a continuous monitoring queue; and
generate a compliance notification to the subscribing real estate professional when a listing previously delivered as a lead is subsequently detected as being relisted or reactivated in a non-expired status.

2. The system of claim 1, further comprising a normalization pipeline module configured to map disparate MLS record fields into a canonical data schema prior to processing by the PEM engine and the RDD engine.

3. The system of claim 1, wherein the PEM engine module schedules delivery at a predetermined time on the Expiration Date.

4. The system of claim 1, wherein the RDD engine module delivers the corresponding lead notification substantially immediately by transmitting the notification within a configurable time period of less than one hour after detecting the status change.

5. The system of claim 1, further comprising a Data Processing Module configured to filter the listing records based on a determination that the property associated with the delisted status has not been re-entered into the MLS as a new active listing.

6. The system of claim 1, wherein the monitoring service module is configured to track the status of the listing for at least 30 days after the listing is delivered as a lead.

7. The system of claim 1, wherein the monitoring service module cross-references a Storage Module containing historical delivery records to determine a subset of subscribing real estate professionals who previously received the lead notification, for targeted delivery of the compliance notification.

8. The system of claim 1, further comprising a User Interface Module configured to allow the subscribing real estate professional to set and apply filtering options based on at least one criteria selected from: geographic location, property type, and price range.

9. The system of claim 1, further comprising a classification module configured to rank or filter the delivered leads using a machine-learning algorithm trained on historical conversion outcomes or anomaly detection.

10. The system of claim 1, further comprising an Alert Communication Module configured to integrate the lead notification with an external customer relationship management (CRM) system used by the subscribing real estate professional.

11. A method for real-time retrieval of real estate listing data, the method comprising:
receiving and normalizing MLS records from a data ingestion interface module;
predictively scheduling a lead notification via a PEM engine module by:
analyzing an Expiration Date field of an active listing record; and
scheduling delivery of the lead notification to a subscribing real estate professional prior to a listing expiration event;
reactively detecting a delisted status in real time via an RDD engine module by:
continuously monitoring the MLS records for status changes;
detecting a transition of a listing to a delisted status, including Cancelled, Terminated, or Withdrawn; and
delivering a corresponding lead notification substantially immediately upon detection; and
continuously monitoring the listing via a monitoring service module by:
maintaining a status lineage record of the listing following delivery of the lead notification; and
automatically generating a compliance notification to the subscribing real estate professional upon detecting a subsequent relisting or reactivation of the property to a non-expired status.

12. The method of claim 11, wherein predictively scheduling delivery comprises selecting a delivery time on the Expiration Date for the active listing that is prior to the listing's actual expiration time.

13. The method of claim 11, further comprising, prior to delivering the corresponding lead notification, the step of filtering the listing using a Data Processing Module to confirm it has not been relisted with a different MLS number

14. The method of claim 11, further comprising aggregating data from multiple real estate markets across different geographical regions prior to the predictive scheduling and reactive detection steps.

15. The method of claim 11, wherein delivering the lead notification and the compliance notification includes transmitting the notification via one or more communication channels selected from: email, SMS, and mobile application push notification via an Alert Communication Module.

16. The method of claim 11, further comprising ranking or filtering the delivered leads using a classification module trained on historical conversion outcomes to prioritize delivery.

17. The method of claim 11, wherein continuously monitoring the listing via the monitoring service module comprises cross-referencing a Storage Module containing historical data to associate the relisted property with the previous lead notification record.
